(19) United States
(12) Patent Application Publication
(10) Pub. No.: US 2003/0234276 A1
(43) Pub. Date: Dec. 25, 2003

(54) Strengthened bonding mechanism for semiconductor package

(75) Inventors: Chung-Che Tsai, Hsinchu (TW); Wei-Heng Shan, Hsinchu (TW)

Correspondence Address: EDWARDS & ANGELL, LLP, P.O. BOX 9169, BOSTON, MA, 02209, US

(73) Assignee: UltraTera Corporation, Hsinchu (TW)

(21) Appl. No.: 10/175,732

(22) Filed: Jun. 20, 2002

(51) Int. Cl. B23K 31/02

(52) U.S. Cl. 228/180.22; 228/248.1

(57) ABSTRACT

A strengthened bonding mechanism for a semiconductor package is proposed. An aluminum pad formed on a chip is formed with a UBM (under bump metallurgy) structure, on which a tin layer is applied. Moreover, a copper pad formed on a substrate or printed circuit board is formed with a tin layer thereon. Thereby, a solder ball or bump is adapted to be bonded to the tin layer for electrical connection purpose. With provision of the tin layer, the solder ball or bump would be strongly bonded to the bonding mechanism without being easily subject to breaking or cracking, thereby making reliability of fabricated products firmly assured. As such, bonding mechanisms can be densely arrangement so as to reduce pitch spacing between adjacent solder balls or bumps bonded to the bonding mechanisms, in favor of fine-pitch structural arrangement for facilitating electrical connection efficiency.

### FIELD OF THE INVENTION

The present invention relates to strengthened bonding mechanisms for semiconductor packages, and more particularly, to a bonding mechanism for use with a semiconductor package, so as to increase bonding strength between a solder ball or bump and the bonding mechanism where the solder ball or bump is bonded.

### BACKGROUND OF TIE INVENTION

A semiconductor package, such as a BGA (ball grid array) package, is characterized by implanting a plurality of array-arranged solder balls at bond pads formed on a substrate. The solder balls serve as I/O (input/output) ports of the semiconductor package, for electrically connecting the semiconductor package to an external device e.g. a printed circuit board (PCB). The semiconductor package can be mounted on the PCB by a conventional SMT (surface mount technology) process in a manner that, the solder balls are respectively bonded to corresponding bond pads formed on the PCB. As such, a chip mounted on the substrate oppositely in position to the solder balls, can be electrically coupled to the PCB for the purposes of power supply, grounding and signal transmission in operation of the chip.

FIG. 4A illustrates a BGA semiconductor package mounted on a printed circuit board (PCB). As shown in the drawing, a plurality of solder balls 10 implanted on a substrate 11 are connected to a PCB 12, allowing a chip 13 mounted on the substrate 11 to be electrically coupled to the PCB in turn through bonding wires 14 and the solder balls 10.

Bond pads (not shown in FIG. 4A) formed on the substrate 11 or PCB 12 where solder balls 10 are bonded, are primarily made of copper (hereinafter referred to as “copper pad”); such a copper pad 15 is structurally illustrated in FIG. 4B. Since fabrication of copper pads 15 employs conventional technology, it is not to be further described herein.

Besides, bond pads are also used for accommodating solder bumps in a flip-chip structure, so as to mediate electrical connection between a flip chip and a substrate. As shown in FIG. 5A, the flip-chip structure is characterized by implanting a plurality of solder bumps 20 on an active surface 210 of a chip 21, allowing the chip 21 to be mounted on a substrate 22 in a face-down manner. The solder bumps 20 for electrically connecting the chip 21 to the substrate 22, are bonded to bond pads (not shown) respectively formed on the active surface 210 and the substrate 22. Such a bond pad 23 formed on the chip 21 is stucturally illustrated in FIG. 5B, and primarily made of aluminum (hereinafter referred to as “aluminum pad”). Then, a passivation layer 24 is applied over the aluminum pad 23, and selectively removed to expose the aluminum pad 23. As the aluminum pad 23 is easily oxidized upon exposure to air and inhospitable to a solder bump, a more hospitable UBM (under bump metallurgy) structure 24 is consequently formed on the aluminum pad 23 for facilitating bump attachment. Since fabrication of the UBM structure 24 adopts conventional technology, it is not to be further described herein. In respect of a bond pad being formed on the substrate 22, it is a copper pad and structured as illustrated in FIG. 4B described above, therefore not further to be here repeated.

However, the above conventional bonding mechanisms are inherent with significant drawbacks. Solder balls or bumps bonded to bond pads formed on a flip chip, substrate or PCB, may be easily subject to breaking or cracking upon exerted with external impact or shear force, due to unsatisfactory bonding strength between solder balls or bumps and the bond pads. Moreover, such solder balls tend to break at ball necks, and damage the underlying structure such as UBM, copper or aluminum pad; this undesirably degrades reliability of fabricated products. In addition, by virtue of unsatisfactory bonding strength and breaking of solder balls or bumps, copper pads or aluminum pads with UBM structures are hardly adapted to be densely arranged for accommodating fine-pitch arrayed solder balls or bumps. This drawback is particular unfavorable for a flip-chip structure, wherein small-sized solder bumps are preferably mounted in high density on a flip chip in compliance with the highly-integrated flip chip.

Therefore, it is highly desired to develop a strengthened bonding mechanism for use with a semiconductor package, so as to increase bonding strength between a solder ball or bump and the bonding mechanism, and to facilitate fine-pitch arrangement of bonding mechanisms and solder balls or bumps.

### SUMMARY OF THE INVENTION

An objective of the present invention is to provide a strengthened bonding mechanism for a semiconductor package, so as to increase bonding strength between a solder ball or bump and the bonding mechanism where the solder ball or bump is bonded, thereby improving reliability of fabricated products.

Another objective of the invention is to provide a strengthened bonding mechanism for a semiconductor package, allowing a solder ball or bump to be strongly bonded to the bonding mechanism, such that bonding mechanisms can be densely formed for accommodating fine-pitch arrangement of solder balls or bumps.

In accordance with the above and other objectives, the present invention proposes a strengthened bonding mechanism for a semiconductor package, comprising: an aluminum pad formed on a chip; a UBM (under bump metallurgy) structure formed over the aluminum pad; and a tin layer applied over the UBM structure, for allowing a solder ball or bump to be bonded to the tin layer, wherein the UBM structure is interposed between the tin layer and the aluminum pad. The UBM structure is composed of at least two layers of metallic materials, such as copper, nickel, vanadium, gold, tungsten, titanium, chromium, aluminum or alloy thereof.

In another embodiment, the strengthened bonding mechanism of the invention comprises: a copper pad formed on a chip carrier; and a tin layer applied over the copper pad, for allowing a solder ball or bump to be bonded to the tin layer; wherein the chip carrier is a substrate or a printed circuit board (PCB).

By the above structure of bonding mechanism, with forming of a tin layer for being mounted with a solder ball or bump thereon, bonding strength between the solder ball or bump and the bonding mechanism would be significantly increased, whereby solder balls or bumps can be strongly bonded to the bonding mechanism formed on a chip, substrate or PCB, without being easily subject to breaking or cracking, making reliability of fabricated products firmly assured. As such, bonding mechanisms can be more densely arranged on the chip, substrate or PCB, for accommodating high density of solder balls or bumps thereon, which effectively facilitates electrical connection efficiency.

### BRIEF DESCRIPTION OF THE DRAWINGS

The present invention can be more fully understood by reading the following detailed description of the preferred embodiments, with reference made to the accompanying drawings, wherein:

FIG. 1 is a cross-sectional view of a first preferred embodiment of a bonding mechanism of the invention;

FIGS. 2A and 2B are cross-sectional views showing embodiments of a UBM structure in the bonding mechanism of FIG. 1;

FIG. 3 is a cross-sectional view of a second preferred embodiment of the bonding mechanism of the invention;

FIGS. 4A and 4B (PRIOR ART) are cross-sectional views respectively showing a conventional BGA semiconductor package, and a bonding mechanism for use with the semiconductor package; and

FIGS. 5A and 5B (PRIOR ART) are cross-sectional views respectively showing a conventional flip-chip semiconductor structure, and a bonding mechanism for use with the semiconductor package.

### DETAILED DESCRIPTION OF THE PREFERRED EMBODIMENT

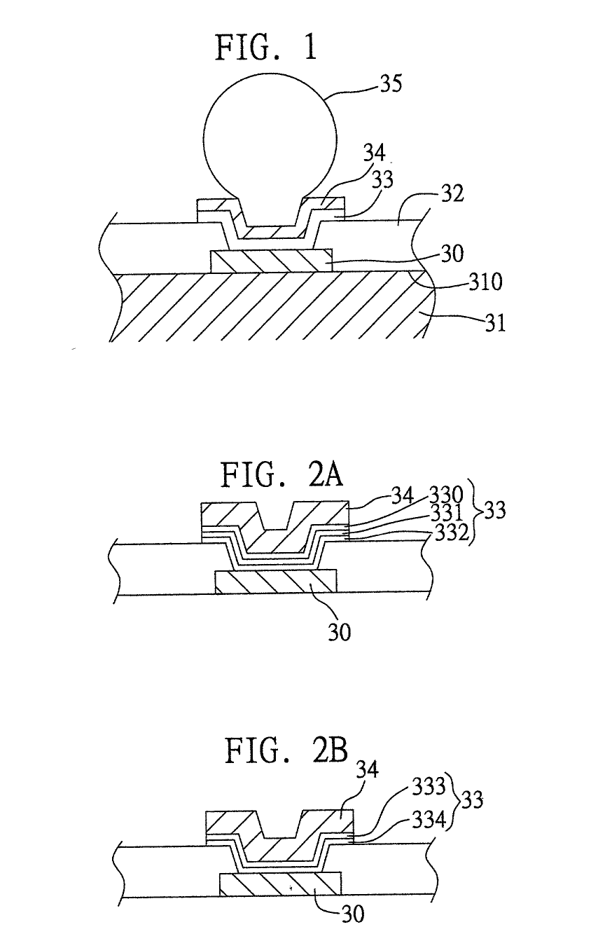

Preferred embodiments of a strengthened bonding mechanism for a semiconductor package proposed in the present invention are described in more detail as follows with reference to FIGS. 1 to 3.

### First Preferred Embodiment

FIG. 1 illustrates a first embodiment of the bonding mechanism of the invention bonded with a solder ball or bump. As shown in the drawing, first, an aluminum pad 30 is formed on an active surface 310 of a chip 31, and exposed by selectively removing a passivation layer 32 applied over the active surface 310 of the chip 31. Since forming of the aluminum pad 30 employs conventional technology, it is not to be further detailed herein.

Then, a UBM (under bump metallurgy) structure 33 is formed over the aluminum pad 30 in a manner as to completely cover the exposed aluminum pad 30 on the chip 31. The UBM structure is composed of at least two layers of metallic materials, such as copper (Cu), nickel (Ni), vanadium (V), gold (Au), tungsten (W), titanium (Ti), chromium (Cr), aluminum (Al), or alloy thereof

Finally, a tin layer 34 is applied over the UBM structure 33, allowing the UBM structure 33 to be interposed between the tin layer 34 and the aluminum pad 30. The tin layer 34 can be made of pure tin, and deposited on the UBM structure 33 by (but not limited to) plating technology. This therefore completes fabrication of the bonding mechanism of the invention, and an electrical connection element 35 such as a solder ball or bump can be readily bonded to the tin layer 34 of the bonding mechanism. In this embodiment, with solder balls or bumps 35 being attached to bonding mechanisms formed on the active surface 310 of the chip 31, the chip 31 can be mounted on a chip carrier e.g. a substrate (not shown) in a face-down manner, allowing the chip 31 to be electrically connected to the substrate by the solder balls or bumps 35 that are interposed between the chip 31 and the substrate; such face-down chip arrangement is customarily referred to as a flip-chip structure.

FIGS. 2A and 2B illustrate embodiments of a UBM structure in the bonding mechanism of the invention. As shown in FIG. 2A, the UBM structure 33 consists of three metallic layers 330, 331, 332, wherein the bottom metallic layer 332 is directly attached to the aluminum pad 30, and the top metallic layer 330 is covered by the tin layer 34. Combinations of the three metallic layers 330, 331, 332 can be, for example, Au/Ni/Cu, Au/W/Ti, Cu/Cr—Cu/Cr, etc. Alternatively, as shown in FIG. 2B, the UBM structure 33 can be made of two metallic layers 333, 334, wherein the tin layer 34 is applied over the upper metallic layer 333, and the aluminum pad 30 is in contact with the lower metallic layer 334. Combinations of the two metallic layers 333, 334 are, for example, Ni/Cu, Cu/Cr, Au/Ni, etc. It should be understood that, embodiments of the UBM structure 33 exemplified herein do not set any restriction to the scope of the invention; much more other combinations for fabricating the UBM structure 33 are suitably adopted in this invention.

The above bonding mechanism of the invention can provide significant benefits. It is a characteristic feature of forming a tin layer on a UBM structure, whereby a solder ball or bump would be strongly bonded to the tin layer of the bonding mechanism without being easily subject to breaking or cracking. A table below illustrates experimental data for testing bonding strength between a solder ball and a bonding mechanism. As shown in the table, a solder ball bonded and reflowed conventionally to a UBM structure formed on an aluminum pad, can only sustain a shear force up to 650 g before it breaks from the UBM structure. In another case, a solder ball reflowed to a tin (Sn) layer formed on a UBM structure would be able to sustain a much greater shear force of 930 g, which indicates around 50% increase in bonding strength by provision of the tin layer in the bonding mechanism. Moreover, if a solder ball bonded to the Sn/UBM structure is exerted with an even greater shear force than 930 g, it would break at Sn/UBM interface, instead of ball neck as for a solder ball directly bonded to a UBM structure. Breakage at Sn/UBM interface would not result in craters formed on the breaking surface, thereby reducing damage to the underlying structure such as UBM, aluminum pad.

| Reflowed to UBM structure | Shear force |
|---|---|
| Solder ball | 650 g |
| Solder ball + tin layer | 930 g |

Therefore, by using the bonding mechanism with a tin layer of the invention, bonding strength between the solder ball or bump and the bonding mechanism would be significantly enhanced, making the solder ball or bump firmly bonded to the bonding mechanism, such that reliability of fabricated products can be greatly improved.

Furthermore, as a solder ball or bump can be strongly bonded to the bonding mechanism of the invention, thereby bonding mechanisms can be densely arranged in a manner as to reduce pitch spacing between adjacent bonding mechanisms. This advantage is important for a flip-chip structure, in which aluminum pads formed on a flip chip are preferably high-density arrayed in compliance with the small sized and highly integrated chip, such that fine-pitch arrangement of solder balls or bumps can be accommodated for achieving desirable electrical connection efficiency.

### Second Preferred Embodiment

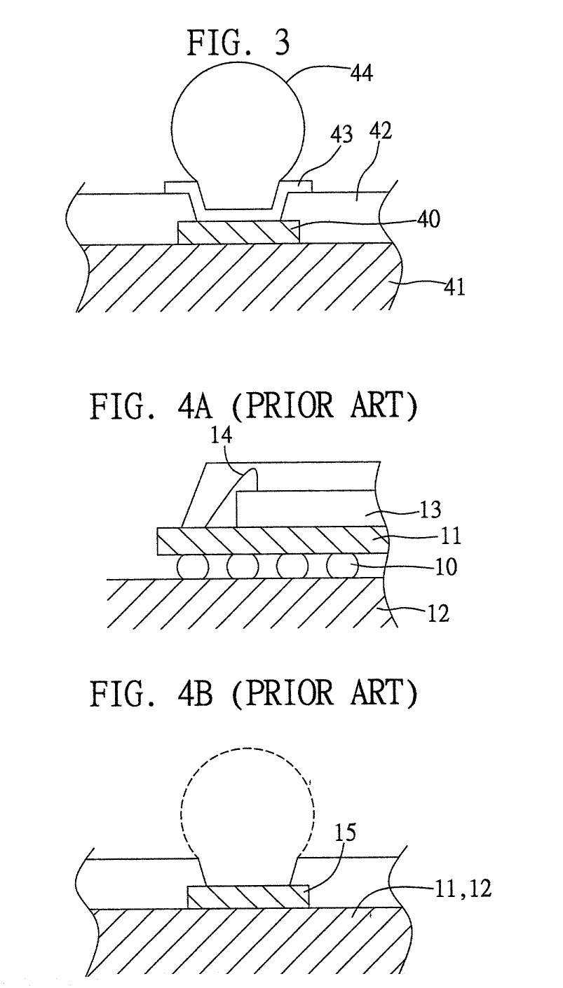

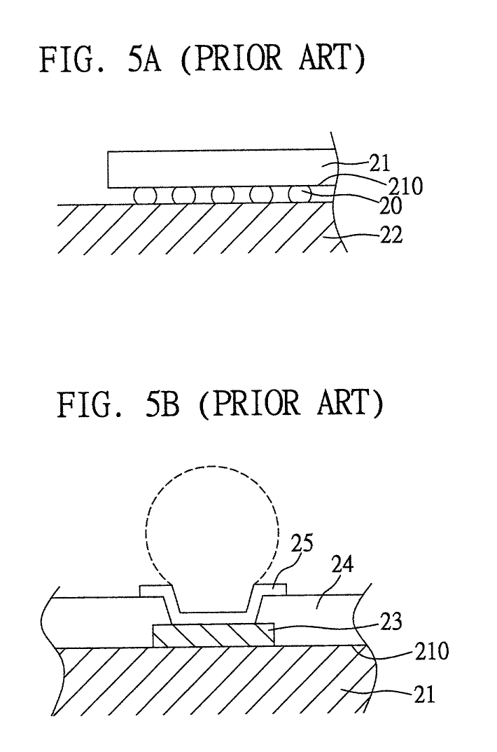

FIG. 3 illustrates a second embodiment of the bonding mechanism of the invention bonded with a solder ball or bump. As shown in the drawing, first, a copper pad 40 is formed on a chip carrier 41 such as a substrate or printed circuit board (PCB); a chip carrier serves for accommodating a chip (not shown) thereon. And, a solder mask layer 42 applied over the chip carrier 41 is selectively removed to expose the copper pad 40. Since fabrication of the copper pad 40 adopts conventional technology, it is not to be further detailed herein.

Then, a tin layer 43 is applied over the copper- pad 40 in a manner as to completely cover the exposed copper pad 40 formed on the chip carrier 41. The tin layer 42 can be made of pure tin, and deposited on the copper pad 40 by (but not limited to) plating technology. This then completes fabrication of the bonding mechanism of the invention, and thereby, an electrical connection element 44 such as a solder ball or bump can be readily bonded to the tin layer 43 of the bonding mechanism.

In the case of the chip carrier 41 being a substrate for use in a semiconductor package such as a BGA package, bonding mechanisms formed on the substrate can be bonded with solder balls or bumps, which serve as I/O ports for electrically connecting a chip (not shown) mounted on the substrate to an external device such as a PCB. Alternatively, bonding mechanisms formed on the substrate are used for accommodating solder balls or bumps bonded to an active surface of a chip (not shown), whereby the chip can be mounted and electrically connected to the substrate in a face-down manner; this forms a flip-chip structure as described above.

In the case of the chip carrier 41 being a PCB, when a BGA semiconductor package is mounted on the PCB by conventional SMT technology, solder balls or bumps as I/O ports of the semiconductor package are adapted to be bonded to bonding mechanisms formed on the PCB.

The above structured bonding mechanism can also provide improvements rendered in the first embodiment. With forming of a tin layer on a copper pad, bonding strength between a solder ball or bump and the bonding mechanism for a substrate or PCB, would be significantly increased, making solder balls or bumps strongly bonded to the substrate or PCB without being easily subject to breaking or cracking, whereby reliability of fabricated products can be firmly assured. As such, bonding mechanisms can be more densely arranged on the substrate or PCB, for accommodating high density of solder balls or bumps thereon, which facilitates electrical connection efficiency. In a flip-chip structure, such a substrate would allow highly effective electrical connection between the substrate and a flip chip. For a BGA semiconductor package mounted on a PCB, solder balls or bumps as I/O ports of the semiconductor package would be firmly bonded to a substrate and the PCB, thereby making electrical connection quality effectively improved.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A strengthened bonding mechanism for a semiconductor package, comprising:
an aluminum pad formed on a chip;
a UBM (under bump metallurgy) structure formed over the aluminum pad; and
a tin layer applied over the UBM structure, for allowing an electrical connection element to be bonded to the tin layer, wherein the UBM structure is interposed between the tin layer and the aluminum pad.

2. The strengthened bonding mechanism of claim 1, wherein the aluminum pad is formed on an active surface of the chip.

3. The strengthened bonding mechanism of claim 1, wherein the tin layer is made of pure tin.

4. The strengthened bonding mechanism of claim 1, wherein the tin layer is applied by plating technology.

5. The strengthened bonding mechanism of claim 1, wherein the UBM structure is composed of at least two layers of metals.

6. The strengthened bonding mechanism of claim 5, wherein the metals are selected from a group consisting of copper, nickel, vanadium, gold, tungsten, titanium, chromium, and aluminum.

7. The strengthened bonding mechanism of claim 1, wherein the electrical connection element is a solder ball.

8. The strengthened bonding mechanism of claim 1, wherein the electrical connection element is a solder bump.

9. A strengthened bonding mechanism for a semiconductor package, comprising:
a copper pad formed on a chip carrier; and
a tin layer applied over the copper pad, for allowing an electrical connection element to be bonded to the tin layer.

10. The strengthened bonding mechanism of claim 9, wherein the chip carrier is a substrate.

11. The strengthened bonding mechanism of claim 9, wherein the chip carrier is a printed circuit board.

12. The strengthened bonding mechanism of claim 9, wherein the tin layer is made of pure tin.

13. The strengthened bonding mechanism of claim 9, wherein the tin layer is applied by plating technology.

14. The strengthened bonding mechanism of claim 9, wherein the electrical connection element is a solder ball.

15. The strengthened bonding mechanism of claim 9, wherein the electrical connection element is a solder bump.
